(19) United States
(12) Patent Application Publication
(10) Pub. No.: US 2023/0075458 A1
(43) Pub. Date: Mar. 9, 2023

(54) MULTIFUNCTIONAL LAMINATOR

(71) Applicant: Weicheng WEI, Heyuan (CN)

(72) Inventor: Weicheng WEI, Heyuan (CN)

(21) Appl. No.: 17/565,478

(22) Filed: Dec. 30, 2021

(30) Foreign Application Priority Data
Sep. 6, 2021 (CN) 2021221342004

(51) Int. Cl. B32B 37/00; B26D 3/10; B26F 1/36; B26D 1/06; B32B 38/00; B32B 38/04

(52) U.S. Cl. CPC B32B 37/0046; B26D 3/10; B26F 1/36; B26D 1/06; B32B 38/0004; B32B 38/04; B32B 2037/0061; B32B 2038/047

(57) ABSTRACT

The utility model discloses a multifunctional laminator, which includes laminator body, corner rounder, hole punch and paper cutter. The top of laminator is set up a storage slot and a cover plate for covering the storage slot, and the first slot is set up in the storage slot, there is a convexity at the end of the first slot to form the second slot. The utility model multifunctional laminator that corner rounder, hole punch and paper cutter are assembled on laminator, so that laminator machine can integrate with laminating, cutting, punching and cutting corner to improve the function of laminator, make it diversified, and flexible in use; in addition, storage slot is set up on the top of laminator, so that laminator is viewed as a whole from the outside, the appearance of multifunctional laminator is beautiful, simple, and reasonable structure.

### CROSS-REFERENCE TO RELATED APPLICATIONS

The application claims priority to Chinese patent application No. 202122134200.4, filed on Sep. 6, 2021, the entire contents of which are incorporated herein by reference.

### TECHNICAL FIELD

The utility model relates to the technical field of office supplies, in particular to a multifunctional laminator.

### BACKGROUND

The laminator is also called plastic laminator, which is mainly composed of a drive system, a heating and temperature control system, an operating control board, front and rear rollers and other components. It is a special equipment for laminating photos or documents. At present, there are many names for the sealing machine in the market. There are those called plastic laminator in China. Hong Kong, Macao and Southeast Asia are used to call glue laminating machines, and they are called laminator in Taiwan

Generally, individuals, companies, schools, even enterprises and agencies have used laminator for the storage and processing of important documents and photos. The size of the photos varies with the way of documents are processed. It needs to be cut and then beautified. Each has its own characteristics and scope of application; however, most of existing laminator products only laminate, resulting in a single function and insufficient flexibility in use, so there are laminators with corner cutting function have appeared on the market, but the corner rounder is set up on the outside or bottom of laminator, which makes the appearance of laminator not beautiful enough.

### SUMMARY

The purpose of the utility model is to provide a multifunctional laminator with reasonable structure, diverse functions, flexible use, simple and beautiful appearance.

In order to solve above technical problems, the utility model can adopt the following technical solutions to achieve:

A multifunctional laminator includes: a laminator body for laminating documents, the top of laminator is set up a storage slot and a cover plate for covering the storage slot, and the first slot is set up in the storage slot, there is a convexity at the end of the first slot to form the second slot;

Corner rounder, to cut the corner of paper to round is installed in the first slot;

Hole punch, to punch hole for paper is installed in the second slot;

paper cutter, to cut the paper is installed in the storage slot.

In one of the embodiments, arc-shaped notches are respectively set up on both sides of the top of the first slot.

In one of the embodiments, after corner rounder is installed in the first slot, the top is lower than or flush with the top of the first slot.

In one of the embodiments, after hole punch is installed in the second slot, the top is lower than or flush with the top of the second slot.

In one of the embodiments, after paper cutter is installed in the storage slot, the top is lower than or flush with the top of the storage slot, then cover corner rounder and hole punch.

In one of the embodiments, the cover plate is connected to the top of laminator by a flip cover, one side of the cover plate is reversibly connected to the top side of laminator, and the other side is opened and closed with the other side of the top of laminator through the buckle and self-locking switch, and the edge of the cover is set up rubber pad.

The beneficial effect of the utility model is: the utility model multifunctional laminator that corner rounder, hole punch and paper cutter are assembled on laminator, so that laminator machine can integrate with laminating, cutting, punching and cutting corner to improve the function of laminator, make it diversified, and flexible in use; in addition, storage slot is set up on the top of laminator, the first and the second slot is set up in the storage slot, respectively used to place paper cutter, corner rounder and hole punch, and then cover the storage slot with the cover plate, so that laminator is viewed as a whole from the outside, the appearance of multifunctional laminator is beautiful, simple, and reasonable structure.

### BRIEF DESCRIPTION OF DRAWINGS

FIG. 1 is the utility model multifunctional laminator structure diagram of the top and cover;

FIG. 2 is the utility model multifunctional laminator structure diagram of corner rounder installation;

FIG. 3 is the utility model multifunctional laminator structure diagram of hole punch installation;

FIG. 4 is the utility model multifunctional laminator structure diagram of paper cutter installation.

### DETAILED DESCRIPTION OF THE EMBODIMENTS

In order to make above features and advantages of the utility model more obvious and easy to understand, the specific implementation of the utility model will be described in detail below with reference to attached drawing. In the following description, many specific details are explained in order to fully understand the utility model. However, the utility model can be implemented in many other ways different from those described here. Those technicians in this field can make similar improvements without violating the connotation of the present utility model. Therefore, the present utility model is not limited by below detail embodiments.

It should be noted that when an element is called “fixed to” another element, it can be directly on the other element or a central element. When an element is considered to be “connected” to another element, it can be directly connected to the other element or a central element at the same time. Oppositely, when an element is called “directly on” another element, there are no central element. The terms “vertical”, “horizontal”, “left”, “right” and similar expressions used here just for illustrative purposes only.

Unless additional defined, all technical and scientific terms used in here have the same meanings as commonly understood by those technicians in this field of the utility model. The terms used in the manual of the utility model are only for the purpose of describing specific implementations, not intend to limit the utility model. The terms used in here “and/or” include any and all combinations of one or more related listed items.

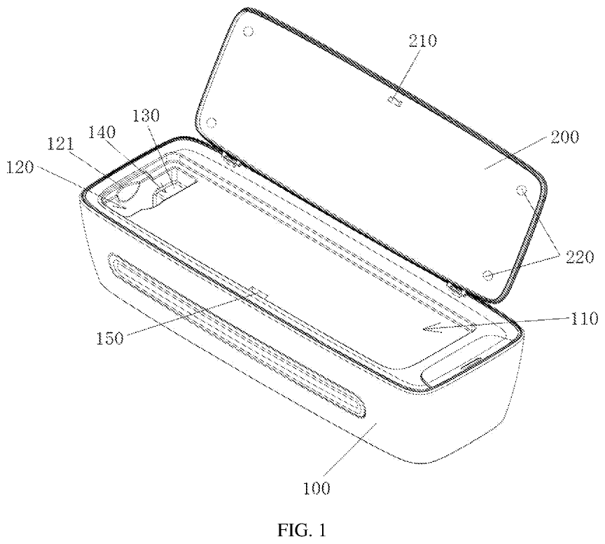

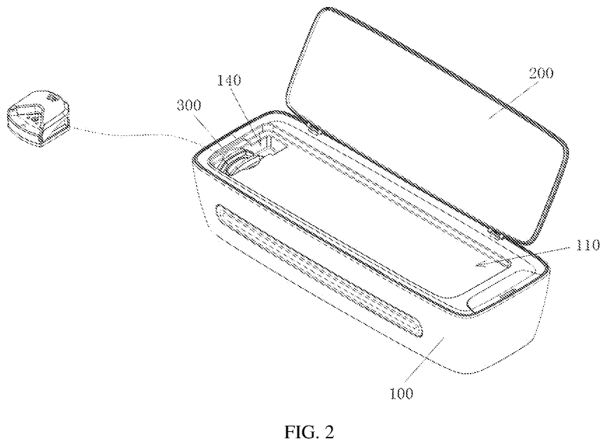

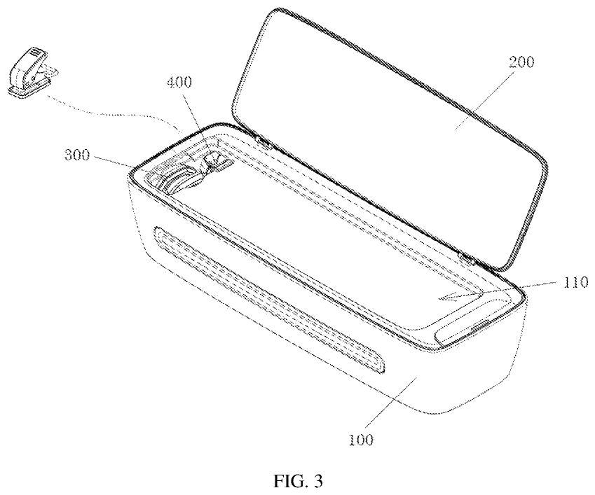

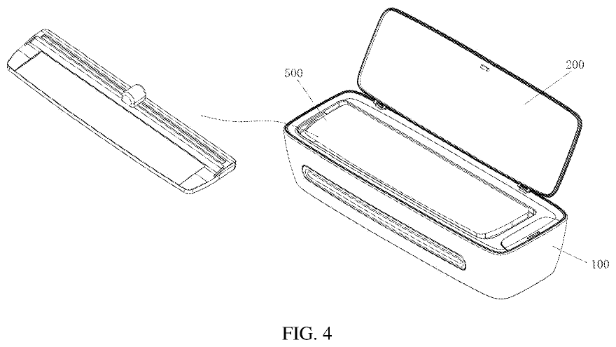

Please refer to FIGS. 1 to 4, a multifunctional laminator, including: laminator body 100, used to laminate documents, on the top of laminator body 100 set up a storage slot 110, and the cover plate 200 to cover storage slot 110, The first slot 120 is set up in the storage slot 110, and the convexity 130 is set up at one end of the first slot 120 to form the second slot 140; corner rounder 300 is used to round the corner of the document and installed in the first slot 120; hole punch 400 is used to punch the document and is installed in the second slot 140; paper cutter 500 is used to cut the document and installed in the storage slot 110.

Specifically, in this embodiment, in order to improve multifunctional laminator, the top of laminator body 100 sets up storage slot 110, and at the same time, the first slot 120 is set up at one side of the storage slot 110, the first slot 120 set up on one side can prevent the first slot 120 from damaging the original structure of laminator body 100. In addition, a convexity 130 is set up at one end of the first slot 120, The second slot 140 is formed by the convexity 130, and corner rounder 300, hole punch 400 and the paper cutter 500 are respectively installed in the first slot 120, the second slot 140 and the storage slot 110. When the document need to be cut, paper cutter 500 is taken out of the storage slot 110 to cut the document, and when the document need to be punched and/or rounded, paper cutter 500 is taken out of the storage slot 110. then take out corner rounder 300 or hole punch 400 to realize the rounding and/or punching of the document. Finally, corner rounder 300, hole punch 400 and paper cutter 500 are integrated into laminator body 100 makes the function of laminator diversified and flexible when using ;After using corner rounder 300, hole punch 400 and paper cutter 500, they can be installed in the first slot 120, the second slot 140 and the storage slot 110, then use cover plate 200 to cover them, so the laminator body 100 is viewed as a whole from outside, and the appearance of the multifunctional laminator is beautiful, simple and reasonable structure.

Please refer to FIGS. 1, because the first slot 120 is set up in the storage slot 110, it is downward backoff in the storage slot 110, and corner rounder 300 is installed in the first slot 120, for the convenience of the corner rounder 300 is taken and placed in the first slot 120. Therefore, arc-shaped notches 121 are respectively set up on both sides of the top of the first slot 120. Corner rounder 300 can be taken out from the arc-shaped notches 121 with fingers, so that it is convenient to pick and place corner rounder 300.

In addition, in this embodiment, in order to make laminator structure reasonable and facilitate the integration of corner rounder 300, hole punch 400, and paper cutter 500. So corner rounder 300 is installed in the first slot 120. Its top is lower than or flush with the top of the first slot 120. Similarly, after hole punch 400 is installed in the second slot 140, the top is lower or flush with the top of the second slot 140, so that paper cutter 500 can be conveniently and reasonably installed in the storage slot 110. After paper cutter 500 is installed in the storage slot 110, the top of paper cutter 500 is lower than or flush with the top of the storage slot 110 that cover corner rounder 300 and hole punch 400, so as to facilitate the covering through the cover plate 200, so that the laminator body 100 can be viewed as a whole from outside, and the appearance is beautiful, simple, and reasonable structure.

Please refer to FIGS. 1, the cover plate 200 is connected with the top of laminator body 100 by a flip cover, one side of the cover plate 200 and the top side of the laminator body 100 are reversibly connected, and the other side is connected through the buckle 210 and self-locking switch 150 is opened and closed with the other side of the top of laminator body 100, and rubber pad 220 is set up on the edge of the cover plate 200.

In this embodiment, in order to conveniently cover the storage slot 110 through the cover plate 200, therefore, the cover plate 200 and the top of laminator body 100 adopt a flip connection method, and one side of the cover plate 200 is connected to one side of the top of laminator body 100 is reversibly connected, and a buckle 210 is set up on the other side of the cover plate 200, and a self-locking switch 150 is set up on the other side of the top of laminator body 100. When the cover plate 200 is turned over to cover the storage slot 110, the buckle 210 is set up on side of the cover plate 200, the self-locking switch 150 is set up on the other side of laminator body 100, so that the cover plate 200 is turned over to cover the storage slot 110. You only need to press the cover plate 200 once to lock the buckle 210 and the self-locking switch 150, so that the cover plate 200 is locked on the top of laminator body 100. Press again to make the cover plate 200 bounce off. This is convenient to open and close the cover plate that store or take the paper cutter 500, the corner rounder 300 and the hole punch 400; at the same time, in order to convenient to press the cover plate 200, it is set up rubber pad 220 around the edge of the cover plate 200, and the rubber pad 200 plays a buffering role, so that the cover plate 200 is reasonable and convenient when it is pressed to lock or press to unlock.

Above shows and describes the basic principles, main features and the advantages of the utility model. All technicians in this profession can smoothly implement the present utility model as shown in the attached drawings of the manual and above description; however, all those technicians who are familiar with this field without departing from the scope of the technical project of the present utility model, equivalent changes can be made, modified and evolved based on above disclosure of technical content. All are equivalent embodiments of the utility model; At the same time, any equivalent changes, modification and evolution, etc., made to the above embodiments based on the essential technology of the present utility model, are still within the scope of protection of the technical solution of this utility model.

What is claimed is:

1. A multifunctional laminator, it's feature includes:
the laminator is used to laminate document;
the top of laminator is set up storage slot and a cover plate for covering the storage slot, and the first slot is set up in the storage slot, there is a convexity at the end of the first slot to form the second slot;
corner rounder, to cut the corner of paper to round is installed in the first slot;
hole punch, to punch hole for paper is installed in the second slot;
paper cutter, to cut the paper is installed in the storage slot.

2. The multifunctional laminator according to claim 1, characterized in that: both sides of the top of the first slot are respectively set up arc-shaped notches.

3. The multifunctional laminator according to claim 2, after corner rounder is installed in the first slot, the top is lower than or flush with the top of the first slot.

4. The multifunctional laminator according to claim 3, after hole punch is installed in the second slot, the top is lower than or flush with the top of the second slot.

5. The multifunctional laminator according to claim 4, after paper cutter is installed in the storage slot, the top is lower than or flush with the top of the storage slot, to cover corner rounder and hole punch.

6. The multifunctional laminator according to claim 1, it's feature: the cover plate is connected to the top of laminator by a flip cover, one side of the cover plate is reversibly connected to the top side of laminator, and the other side is opened and closed with the other side of the top of laminator through the buckle and self-locking switch, and the edge of the cover is set up rubber pad.
